(19) United States
(12) Patent Application Publication
(10) Pub. No.: US 2023/0222483 A1
(43) Pub. Date: Jul. 13, 2023

(54) Server, ETCS Terminal and Method of Controlling the Same

(71) Applicants: Hyundai Motor Company, Seoul (KR); Kia Corporation, Seoul (KR)

(72) Inventors: Seung Jae Lee, Gwangmyeong-si (KR); Haeyoung Kwon, Suwon-si (KR)

(21) Appl. No.: 17/985,626

(22) Filed: Nov. 11, 2022

(30) Foreign Application Priority Data
Jan. 7, 2022 (KR) 10-2022-0002619

(51) Int. Cl. G06Q 20/34; G06Q 20/40

(52) U.S. Cl. CPC G06Q 20/341; G06Q 20/401; G06Q 2240/00

(57) ABSTRACT

An embodiment server comprises a communicator; and a controller configured to control the communicator, wherein the controller is configured to: in response to receiving connected car service (CCS) subscription information and card information from a vehicle through the communicator, determine whether a card issued to a card integrated circuit (IC) chip of an electronic toll collection system (ETCS) terminal of the vehicle is valid, based on the CCS subscription information and the card information; in response to the card being valid, control the communicator to transmit a normal card confirmation message comprising a security key to the vehicle; and in response to the card being invalid, control the communicator to transmit a card deletion command comprising an authorization key to the vehicle.

### CROSS-REFERENCE TO RELATED APPLICATIONS

This application claims the benefit of Korean Patent Application No. 10-2022-0002619, filed on Jan. 7, 2022, which application is hereby incorporated herein by reference.

### TECHNICAL FIELD

The disclosure relates to a server that manages a card of an electronic toll collection system (ETCS) terminal, the ETCS terminal, and a method of controlling the same.

### BACKGROUND

An electronic toll collection system (ETCS) such as HI-PASS automatically charges users a toll by using a standardized application interface of the Dedicated Short-Range Communication protocols in order to reduce traffic delays.

That is, the ETCS is a system capable of automatically transmitting and receiving toll information between roadside equipment and a terminal of a vehicle (on-board equipment or ETCS terminal), based on Dedicated Short-Range Communications.

For toll transaction processing, when a vehicle approaches, the ETCS recognizes a class of vehicle by a vehicle classification device and transmits information through a transmission and reception antenna on a lane by linking to a terminal installed in the vehicle.

Recently, instead of inserting a credit card into an ETCS terminal, a card integrated circuit (IC) chip is embedded in the ETCS terminal and card information issued by a card company is input into the card IC chip, thereby preventing structural restrictions or theft risk that may be caused when using a physical credit card.

### SUMMARY

An embodiment of the disclosure provides a server, an electronic toll collection system (ETCS) terminal, and a method of controlling the same that may determine a validity of a card issued to the ETCS terminal and control deletion or activation of the card.

Additional embodiments of the disclosure will be set forth in part in the description which follows and, in part, will be obvious from the description, or may be learned by practice of the disclosure.

According to an embodiment of the disclosure, there is provided a server including a communicator, and a controller configured to control the communicator, wherein the controller is configured to in response to receiving connected car service (CCS) subscription information and card information from a vehicle through the communicator, determine whether a card issued to a card integrated circuit (IC) chip of an electronic toll collection system (ETCS) terminal of the vehicle is valid, based on the CCS subscription information and the card information; in response to the card being valid, control the communicator to transmit a normal card confirmation message including a security key to the vehicle, and in response to the card being invalid, control the communicator to transmit a card deletion command including an authorization key to the vehicle.

The controller is configured to determine whether an expiration date of the card has elapsed based on the card information, and in response to the expiration date having elapsed, determine that the card is invalid.

The controller is configured to determine whether customer information of the CCS subscription information and customer information of the card information match, and in response to the customer information of the CCS subscription information not matching the customer information of the card information, determine that the card is invalid.

The controller is configured to determine whether vehicle information of the CCS subscription information and vehicle information of the card information match, and in response to the vehicle information of the CCS subscription information not matching the vehicle information of the card information, determine that the card is invalid.

The controller is configured to determine whether a request for deleting the card is existent based on a card serial number of the card information, and in response to the request for deleting the card being existent, determine that the card is invalid.

In response to receiving the request for deleting the card from a user terminal through the communicator, the controller is configured to deliver the request for deleting the card to a server of a card company and control the communicator to transmit the card deletion command including the authorization key to the vehicle.

In response to receiving the request for deleting the card from a server of a card company through the communicator, the controller is configured to control the communicator to transmit the card deletion command including the authorization key to the vehicle.

According to an embodiment of the disclosure, there is provided an ETCS terminal including: a communication interface configured to be connected to a vehicle network of a vehicle; a card IC chip configured to store card information of an issued card; and a controller configured to control the communication interface to transmit the card information to a head unit of the vehicle, and in response to a response not being received within a predetermined period of time after transmitting the card information, control the card IC chip to deactivate a card issued to the card IC chip.

In response to receiving a normal card confirmation message including a security key from the head unit through the communication interface, the controller is configured to activate the card issued to the card IC chip using the security key.

In response to receiving a card deletion command including an authorization key from the head unit through the communication interface, the controller is configured to delete the card issued to the card IC chip using the authorization key.

According to an embodiment of the disclosure, there is provided a method of controlling a server including a communicator, including: in response to receiving CCS subscription information and card information from a vehicle through the communicator, determining whether a card issued to a card IC chip of an ETCS terminal of the vehicle is valid, based on the CCS subscription information and the card information; in response to the card being valid, controlling the communicator to transmit a normal card confirmation message including a security key to the vehicle; and in response to the card being invalid, controlling the communicator to transmit a card deletion command including an authorization key to the vehicle.

The determining of whether the card is valid includes determining whether an expiration date of the card has elapsed based on the card information, and in response to the expiration date of the card having elapsed, determining that the card is invalid.

The determining of whether the card is valid includes determining whether customer information of the CCS subscription information and customer information of the card information match, and in response to the customer information of the CCS subscription information not matching the customer information of the card information, determining that the card is invalid.

The determining of whether the card is valid includes determining whether vehicle information of the CCS subscription information and vehicle information of the card information match, and in response to the vehicle information of the CCS subscription information not matching the vehicle information of the card information, determining that the card is invalid.

The determining of whether the card is valid includes determining whether a request for deleting the card is existent based on a card serial number of the card information, and in response to the request for deleting the card being existent, determining that the card is invalid.

The method of controlling the server further includes, in response to receiving the request for deleting the card from a user terminal through the communicator, delivering the request for deleting the card to a server of a card company and controlling the communicator to transmit the card deletion command including the authorization key to the vehicle.

The method of controlling the server further includes, in response to receiving the request for deleting the card from a server of a card company through the communicator, controlling the communicator to transmit the card deletion command including the authorization key to the vehicle.

According to an embodiment of the disclosure, there is provided a method of controlling an ETCS terminal including a communication interface, connected to a vehicle network of a vehicle, and a card IC chip configured to store card information of an issued card, the method including: controlling the communication interface to transmit the card information to a head unit of the vehicle; and in response to a response not being received within a predetermined period of time after transmitting the card information, controlling the card IC chip to deactivate a card issued to the card IC chip.

The method of controlling the ETCS terminal further includes, in response to receiving a normal card confirmation message including a security key from the head unit through the communication interface, activating the card issued to the card IC chip using the security key.

The method of controlling the ETCS terminal further includes, in response to receiving a card deletion command including an authorization key from the head unit through the communication interface, deleting the card issued to the card IC chip using the authorization key.

### BRIEF DESCRIPTION OF THE DRAWINGS

These and/or other embodiments of the disclosure will become apparent and more readily appreciated from the following description of the embodiments, taken in conjunction with the accompanying drawings of which:

FIG. 1 illustrates an electronic toll collection system (ETCS) card management system according to an embodiment;

FIG. 2 is a control block diagram illustrating a server according to an embodiment;

FIG. 3 is a control block diagram illustrating a vehicle according to an embodiment;

FIG. 4 is a signal flow graph when a server according to an embodiment determines that a card of an ETCS terminal is valid;

FIG. 5 is a signal flow graph when a server according to an embodiment determines that a card of an ETCS terminal is invalid;

FIG. 6 is a diagram illustrating an example where a server according to an embodiment determines a validity of a card of an ETCS terminal;

FIG. 7 is a signal flow graph when an ETCS terminal according to an embodiment deactivates a card issued to a card integrated circuit (IC) chip;

FIG. 8 is a signal flow graph when a server according to an embodiment receives a card deletion request from a user;

FIG. 9 is a signal flow graph when a server according to an embodiment receives a card deletion request from a card company;

FIG. 10 is a flowchart illustrating operations of determining a validity of a card by an ETCS terminal in a method of controlling a server according to an embodiment;

FIG. 11 is a flowchart illustrating operations of receiving a card deletion request from a user or a card company in a method of controlling a server according to an embodiment; and

FIG. 12 is a flowchart illustrating operations of deactivating a card issued to a card IC chip in a method of controlling an ETCS terminal according to an embodiment.

### DETAILED DESCRIPTION OF ILLUSTRATIVE EMBODIMENTS

Like reference numerals throughout the specification denote like elements. Also, this specification does not describe all the elements according to embodiments of the disclosure, and descriptions well-known in the art to which the disclosure pertains or overlapped portions are omitted.

It will be understood that when an element is referred to as being “connected” to another element, it can be directly or indirectly connected to the other element, wherein the indirect connection includes “connection” via a wireless communication network.

It will be understood that the term “include” when used in this specification, specifies the presence of stated features, integers, steps, operations, elements, and/or components, but do not preclude the presence or addition of one or more other features, integers, steps, operations, elements, components, and/or groups thereof.

It is to be understood that the singular forms are intended to include the plural forms as well, unless the context clearly dictates otherwise.

The terms such as “~part”, “~device”, “~member”, “~module”, “~block”, and the like may refer to a unit for processing at least one function or act. For example, the terms may refer to at least process processed by at least one hardware, such as field-programmable gate array (FPGA)/application specific integrated circuit (ASIC), software stored in memories or processors.

Reference numerals used for method steps are just used for convenience of explanation, but not to limit an order of the steps. Thus, unless the context clearly dictates otherwise, the written order may be practiced otherwise.

Hereinafter, a server, an electronic toll collection system (ETCS) terminal and a method of controlling the same according to embodiments of the disclosure will be described in detail with reference to the accompanying drawings.

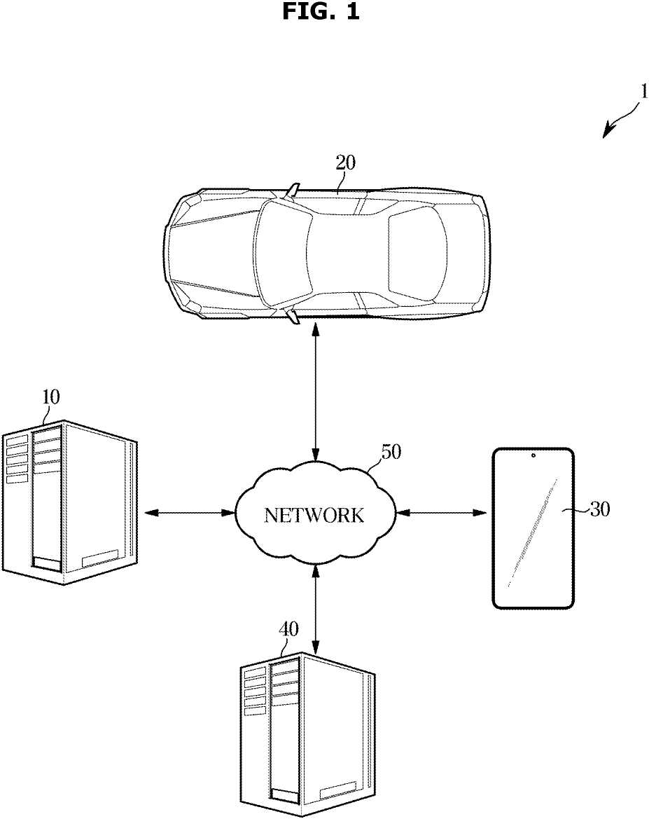

FIG. 1 illustrates an ETCS card management system according to an embodiment.

Referring to FIG. 1, an ETCS card management system 1 according to an embodiment includes a server 10 providing a connected car service (CCS) for a vehicle 20, the vehicle 20 including an ETCS terminal, a user terminal 30 and a card company server 40 issuing a card to the ETCS terminal.

Each of the server 10, the vehicle 20, the user terminal 30 and the card company server 40 may be connected to a network 50 by wire or wirelessly, and transmit and receive data with each other through the network 50.

According to an embodiment, the server 10 may determine a validity of a card issued to a card integrated circuit (IC) chip of the ETCS terminal of the vehicle 20. Also, when the card is valid, the server 10 may transmit a normal card confirmation message including a security key to the ETCS terminal of the vehicle 20, and when the card is invalid, transmit a card deletion command including an authorization key to the ETCS terminal of the vehicle 20. As such, the server 10 may manage the card (e.g., an embedded HI-PASS card) issued to the card IC chip of the ETCS terminal via a CCS network.

According to an embodiment, when receiving the normal card confirmation message or the card deletion command from the server 10, the vehicle 20 may deliver the normal card confirmation message or the card deletion command to the ETCS terminal.

The ETCS terminal of the vehicle 20 may transmit card information to a head unit of the vehicle 20, and the head unit transmits the card information and CCS subscription information to the server 10, thereby enabling the server 10 to determine the validity of the card issued to the card IC chip of the ETCS terminal.

In an embodiment, when a response is not received within a predetermined period of time after transmitting the card information to the head unit, the ETCS terminal of the vehicle 20 may determine that the ETCS terminal is relocated from the vehicle 20 and is connected to an external power, or that the CCS is cancelled, and deactivate the card of the card IC chip. Through the above, the ETCS terminal may be prevented from being forcibly relocated and misused.

According to an embodiment, the user terminal 30 may receive an input from a driver of the vehicle 20. For example, the user terminal 30 may receive a request for deleting the card issued to the card IC chip of the ETCS terminal from the driver’s input, and transmit the request for deleting the card to the server 10 based on the driver’s input.

According to an embodiment, the card company server 40 may generate card information about a card to be issued to the card IC chip of the ETCS terminal, and deliver to the server 10. When the card has expired or a payment is outstanding, the card company server 40 may transmit a card deletion request to the server 10.

As such, when receiving the card deletion request from the user terminal 30 or the card company server 40, the server 10 may transmit the card deletion command to the ETCS terminal of the vehicle 20.

The constituent components of the ETCS card management system 1 and the relationships thereof have been described above. Hereinafter, the constituent components are described in greater detail.

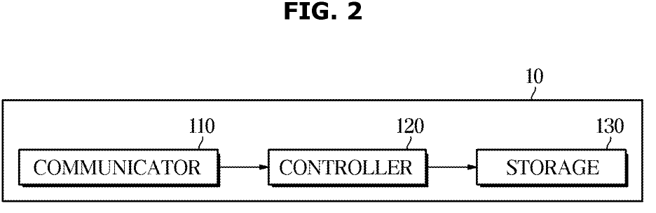

FIG. 2 is a control block diagram illustrating the server 10 according to an embodiment.

Referring to FIG. 2, the server 10 according to an embodiment includes a communicator 110, a controller 120 and a storage 130. Here, the controller 120 determines a validity of a card issued to a card IC chip of an ETCS terminal of the vehicle 20 and controls transmission of a signal, corresponding to a result of the determination, to the ETCS terminal. The storage 130 stores various information required for control.

According to an embodiment, the communicator 110 is connected to the network 50 to transmit and receive data with the vehicle 20, the user terminal 30 and the card company server 40. To this end, the communicator 110 may be provided as a known type of communication module.

According to an embodiment, when receiving CCS subscription information and card information from the vehicle 20, the controller 120 may determine whether the card issued to the card IC chip of the ETCS terminal of the vehicle 20 is valid based on the CCS subscription information and the card information.

In this instance, the CCS subscription information may include vehicle information (e.g., vehicle identification number (VIN)) and customer information subscribed to the CCS.

Also, the card information may include expiration date, card serial number, issuance-eligible customer information and issuance-eligible vehicle information.

According to embodiments, the controller 120 may determine whether an expiration date of the card has passed based on the card information, and when the expiration date of the card has not arrived, determine that the card is valid, and also when the expiration date of the card has arrived, determine that the card is invalid.

According to embodiments, the controller 120 may determine whether the customer information of the CCS subscription information and the issuance-eligible customer information of the card information match, and when the customer information of the CCS subscription information matches the issuance-eligible customer information of the card information, determine that the card is valid, and also when the customer information of the CCS subscription information does not match the issuance-eligible customer information of the card information, determine that the card is invalid.

According to embodiments, the controller 120 may determine whether the vehicle information of the CCS subscription information and the issuance-eligible vehicle information of the card information match, and when the vehicle information of the CCS subscription information matches the issuance-eligible vehicle information of the card information, determine that the card is valid, and also when the vehicle information of the CCS subscription information does not match the issuance-eligible vehicle information of the card information, determine that the card is invalid.

According to embodiments, the controller 120 may determine whether there has been a request for deleting the card based on the card serial number of the card information, and when there has been the request for deleting the card, determine that the card is invalid.

According to an embodiment, when the card is valid, the controller 120 may control the communicator 110 to transmit a normal card confirmation message including a security key to the vehicle 20. In this instance, the security key corresponds to a key capable of activating a payment function of the card, and may be issued by a personal secure application module (PerSAM). The PerSAM is a card-type security device that is required to be used only according to a specified procedure in order to securely deliver a key for issuing a card (electronic currency). That is, the PerSAM is a module having key information required for issuance, and may be provided by the Korea Expressway Corporation in charge of ETCS.

According to an embodiment, when the card is invalid, the controller 120 may control the communicator 110 to transmit a card deletion command including an authorization key to the vehicle 20. In this instance, the authorization key corresponds to a key having an authority to delete the card and may be issued by the PerSAM.

According to an embodiment, when receiving the request for deleting the card from the user terminal 30 through the communicator 110, the controller 120 may deliver the request for deleting the card to the card company server 40 and control the communicator 110 to transmit the card deletion command including the authorization key to the vehicle 20.

According to an embodiment, when receiving the request for deleting the card from the card company server 40 through the communicator 110, the controller 120 may control the communicator 110 to transmit the card deletion command including the authorization key to the vehicle 20.

The controller 120 may include at least one memory storing a program for performing the aforementioned operations and operations described below, and at least one processor for implementing a stored program. When a plurality of memories and processors are provided, the plurality of memories and processors may be integrated into one chip, or provided in physically separated locations.

According to an embodiment, the storage 130 may store a variety of modules (e.g., PerSAM) required for deleting or issuing the card, and card information corresponding to an issued card. To this end, the storage 130 may be provided as a known type of storage medium.

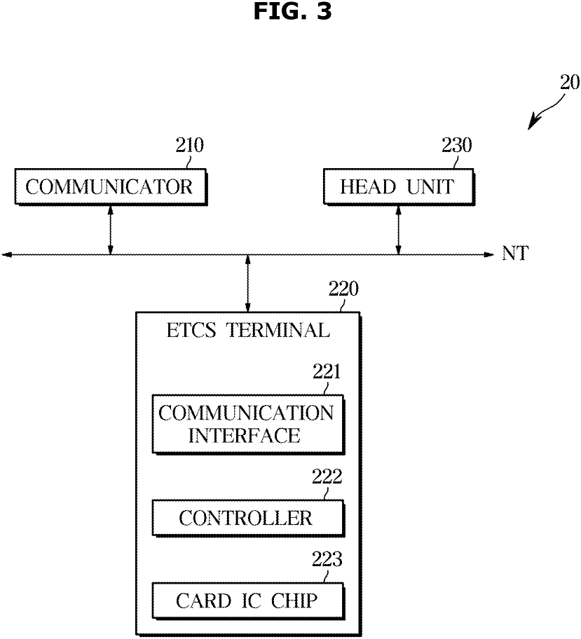

FIG. 3 is a control block diagram illustrating the vehicle 20 according to an embodiment.

Referring to FIG. 3, the vehicle 20 according to an embodiment includes a communicator 210, an ETCS terminal 220 including a card IC chip 223, and a head unit 230 controlling a CCS.

Each of the communicator 210, the ETCS terminal 220 and the head unit 230 is connected to a vehicle network (NT) and may transmit and receive data with each other.

According to an embodiment, the communicator 210 is wirelessly connected to the network 50 to perform communication with the server 10. To this end, the communicator 210 may be a known type of wireless communication module.

According to an embodiment, the ETCS terminal 220 may include a communication interface 221 connected to the vehicle network (NT) to perform communication, a controller 222 controlling card issuance and card deletion, and the card IC chip 223 in which card information of an issued card is input and which performs payment.

According to an embodiment, the communication interface 221 is connected to the vehicle network (NT) to perform communication. To this end, the communication interface 221 may be provided as a known type of communication module.

According to an embodiment, the controller 222 may control the communication interface 221 to transmit card information to the head unit 230 of the vehicle 20.

According to an embodiment, when receiving a normal card confirmation message including a security key from the head unit 230 through the communication interface 221 in response to the transmission of the card information, the controller 222 may activate a card issued to the card IC chip using the security key.

According to an embodiment, when receiving a card deletion command including an authorization key from the head unit 230 through the communication interface 221 in response to the transmission of the card information, the controller 222 may delete the card issued to the card IC chip using the authorization key. In this instance, deleting the card issued to the card IC chip may be deleting an applet and a supplementary security domain (SSD) corresponding to the card.

According to an embodiment, when a response is not received within a predetermined period of time after transmitting the card information to the head unit 230 of the vehicle 20, the controller 222 may control the card IC chip 223 to deactivate the card issued to the card IC chip. That is, when the response is not received after the transmission of the card information, the controller 222 may determine that the ETCS terminal is relocated from the vehicle 20 and is connected to an external power, or that the CCS is cancelled, and deactivate the card of the card IC chip, thereby preventing payment. Through the above, the ETCS terminal may be prevented from being forcibly relocated and misused.

The controller 222 may include at least one memory storing a program for performing the aforementioned operations and operations described below, and at least one processor for implementing a stored program. When a plurality of memories and processors are provided, the plurality of memories and processors may be integrated into one chip, or provided in physically separated locations.

According to an embodiment, the card IC chip 223 may perform payment based on the card information of the issued card. That is, the card IC chip 223 may perform payment based on fee information received from roadside equipment.

To this end, the card IC chip 223 may include an issuer security domain (ISD) which is initially permanently installed in the card IC chip 223 by an initial card issuer (e.g., a manufacturer of the vehicle 20) and a SSD which is installed by a service provider (card company) providing a payment service and requires to manage a separate key. In this instance, deletion and change of the card information may be performed only by the ISD and a structure of a security domain (SD) including the ISD and the SSD may comply with a GlobalPlatform (GP) card specification.

According to an embodiment, the head unit 230 may control the CCS. That is, the head unit 230 may store CCS subscription information and transmit and receive data with the server 10 through the communicator 210 based on the CCS subscription information.

For example, when receiving the card information from the ETCS terminal 220, the head unit 230 may control the communicator 210 to transmit the CCS subscription information and the card information to the server 10, and deliver the normal card confirmation message or the card deletion command received from the server 10 through the communicator 210 to the ETCS terminal 220.

The constituent components of the server 10 and the vehicle 20 have been described above. Hereinafter, the server 10 that determines a validity of a card is described in detail.

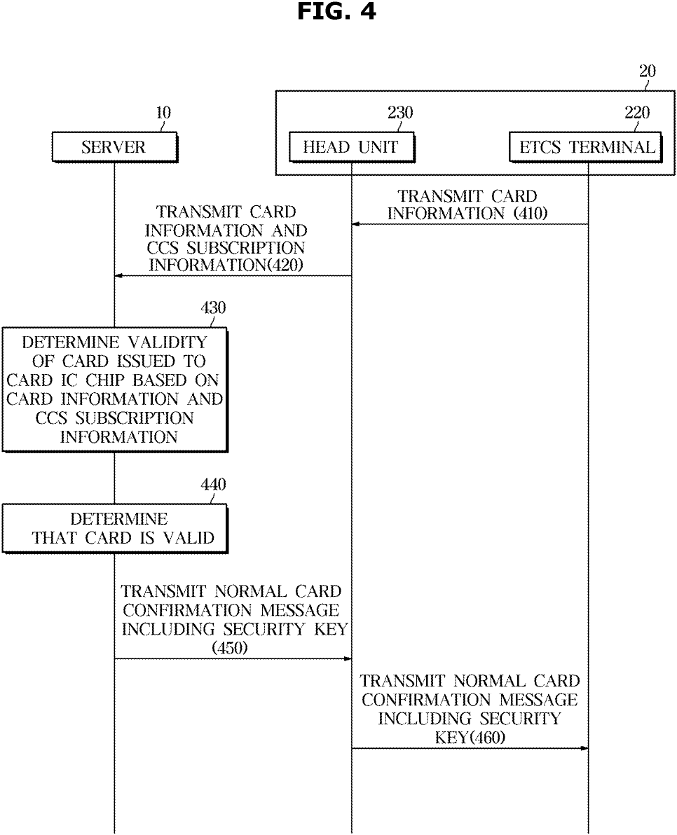

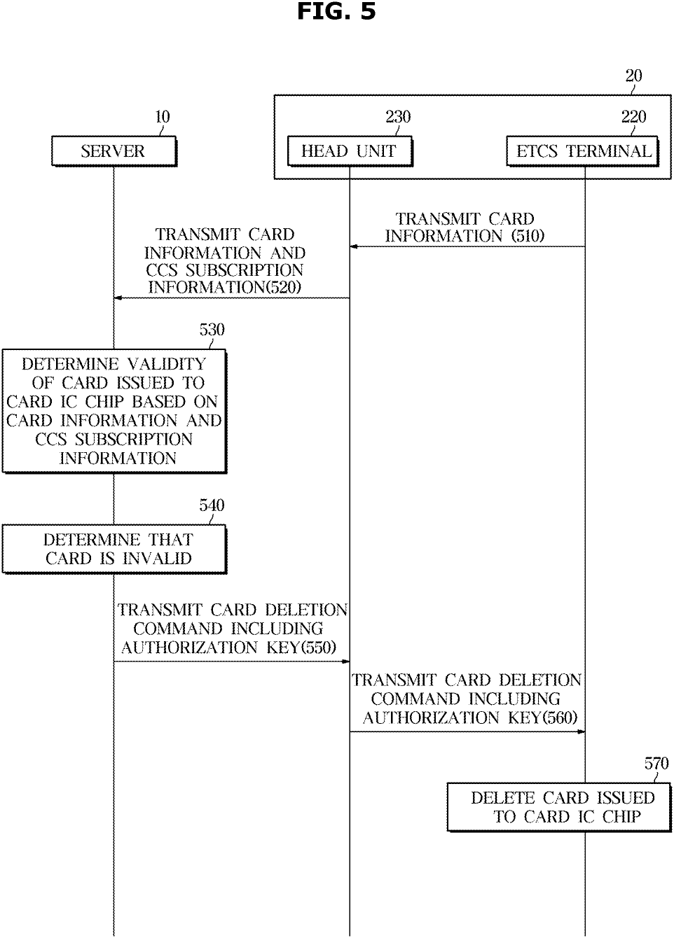

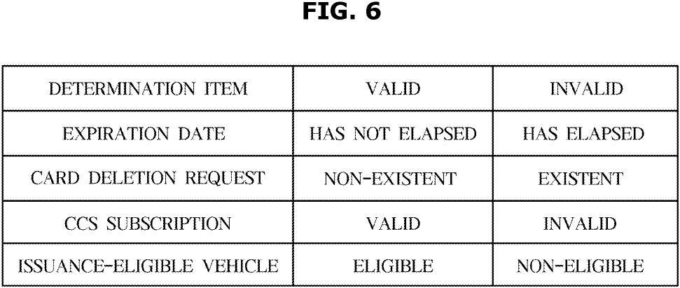

FIG. 4 is a signal flow graph when the server 10 according to an embodiment determines that a card of the ETCS terminal 220 is valid. FIG. 5 is a signal flow graph when the server 10 according to an embodiment determines that a card of the ETCS terminal 220 is invalid. FIG. 6 is a diagram illustrating an example where the server 10 according to an embodiment determines a validity of a card of the ETCS terminal 220.

Referring to FIG. 4, the ETCS terminal 220 according to an embodiment may transmit card information to the head unit 230 (410). In this instance, the card information may include an expiration date, card serial number, issuance-eligible customer information and issuance-eligible vehicle information.

According to an embodiment, when receiving the card information from the ETCS terminal 220, the head unit 230 may transmit the card information and CCS subscription information to the server 10 (420). In this instance, the CCS subscription information may include vehicle information (e.g., vehicle identification number (VIN)) and customer information subscribed to a CCS.

According to an embodiment, the server 10 may determine a validity of a card issued to the card IC chip 223, based on the card information and the CCS subscription information (430).

Specifically, as shown in FIG. 6, the server 10 may determine the validity of the card issued to the card IC chip 223, based on at least one of whether an expiration date has elapsed, whether a card deletion request is existent, or whether a CCS subscription is valid.

For example, according to embodiments, the server 10 may determine whether an expiration date of the card has passed based on the card information, and when the expiration date of the card has not arrived, determine that the card is valid, and also when the expiration date of the card has arrived, determine that the card is invalid.

According to embodiments, the server 10 may determine whether the customer information of the CCS subscription information and the issuance-eligible customer information of the card information match, and when the customer information of the CCS subscription information matches the issuance-eligible customer information of the card information, determine that the card is valid, and also when the customer information of the CCS subscription information does not match the issuance-eligible customer information of the card information, determine that the card is invalid.

According to embodiments, the server 10 may determine whether the vehicle information of the CCS subscription information and the issuance-eligible vehicle information of the card information match, and when the vehicle information of the CCS subscription information matches the issuance-eligible vehicle information of the card information, determine that the card is valid, and also when the vehicle information of the CCS subscription information does not match the issuance-eligible vehicle information of the card information, determine that the card is invalid.

According to embodiments, the server 10 may determine whether there has been a request for deleting the card based on the card serial number of the card information, and when there has been the request for deleting the card, determine that the card is invalid.

According to an embodiment, when the card is determined to be valid (440), the server 10 may transmit a normal card confirmation message including a security key to the vehicle 20 (450). In this instance, the security key corresponds to a key capable of activating a payment function of the card, and may be issued by a PerSAM. The PerSAM is a card-type security device that is required to be used only according to a specified procedure in order to securely deliver a key for issuing a card (electronic currency). That is, the PerSAM is a module having key information required for issuance, and may be provided by the Korea Expressway Corporation in charge of ETCS.

According to an embodiment, when receiving the normal card confirmation message from the server 10, the head unit 230 may deliver the normal card confirmation message to the ETCS terminal 220 (460). When receiving the normal card confirmation message including the security key from the head unit 230 through the communication interface 221 in response to the transmission of the card information, the ETCS terminal 220 may activate the card issued to the card IC chip using the security key to perform payment.

Referring to FIG. 5, operations 510 to 530 may be the same as the above description regarding operations 410 to 430.

According to an embodiment, when the card is determined to be invalid (540), the server 10 may transmit a card deletion command including an authorization key to the vehicle 20 (550). In this instance, the authorization key corresponds to a key having an authority to delete the card and may be issued by the PerSAM.

According to an embodiment, when receiving the card deletion command from the server 10, the head unit 230 may deliver the card deletion command to the ETCS terminal 220 (560).

In this case, when receiving the card deletion command including the authorization key from the head unit 230 through the communication interface 221 in response to the transmission of the card information, the ETCS terminal 220 may delete the card issued to the card IC chip using the authorization key (570). In this instance, deleting the card issued to the card IC chip may be deleting an applet and a SSD corresponding to the card.

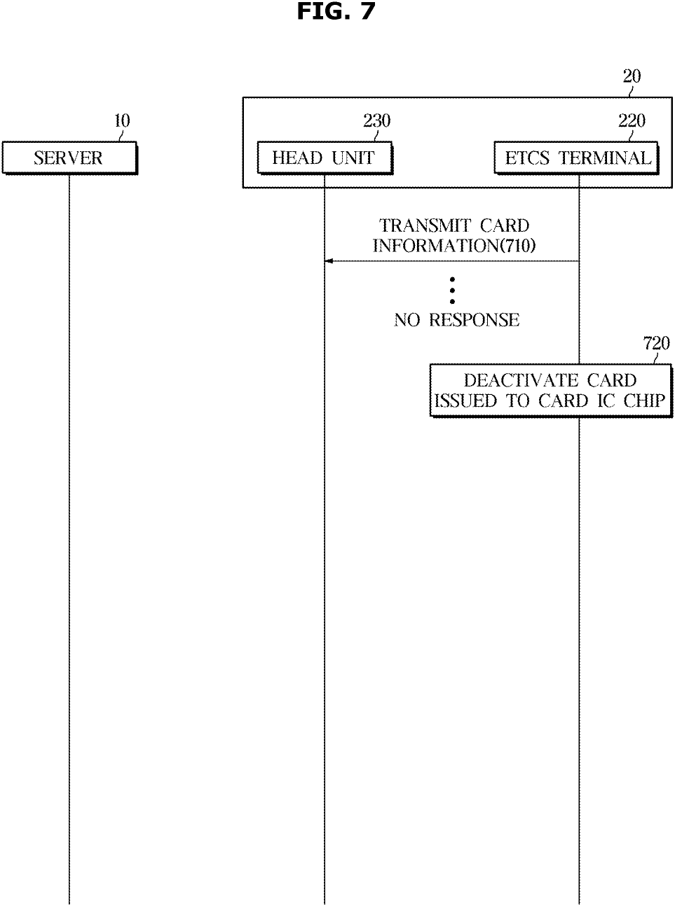

FIG. 7 is a signal flow graph when the ETCS terminal 220 according to an embodiment deactivates a card issued to the card IC chip 223.

Referring to FIG. 7, the ETCS terminal 220 according to an embodiment may transmit card information (710).

According to an embodiment, when a response is not received within a predetermined period of time after transmitting the card information, the ETCS terminal 220 may deactivate the card issued to the card IC chip (720).

That is, when the response is not received after the transmission of the card information, the ETCS terminal 220 may determine that the ETCS terminal is relocated from the vehicle 20 and is connected to an external power, or that the CCS is cancelled, and deactivate the card of the card IC chip, thereby preventing payment. Through the above, the ETCS terminal may be prevented from being forcibly relocated and misused.

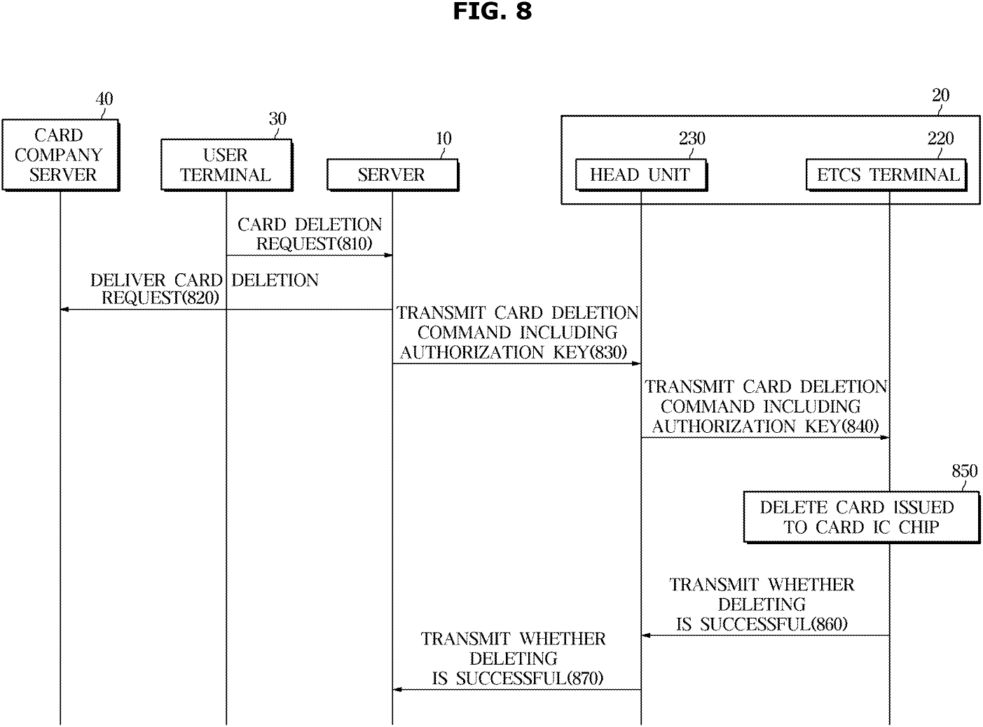

FIG. 8 is a signal flow graph when the server 10 according to an embodiment receives a card deletion request from a user.

Referring to FIG. 8, the user terminal 30 according to an embodiment may request the server 10 for a card deletion based on a user input (810).

According to an embodiment, the server 10 may deliver the request for deleting the card to the card company server 40 (820), and transmit a card deletion command including an authorization key to the vehicle 20 (830).

According to an embodiment, when receiving the card deletion command from the server ₁₀, the head unit 230 may deliver the card deletion command to the ETCS terminal 220 (840). The ETCS terminal 220 may delete a card issued to the card IC chip using the authorization key (850). In this instance, deleting the card issued to the card IC chip may be deleting an applet and a SSD corresponding to the card. Also, the ETCS terminal 220 may transmit whether the deleting is successful to the head unit 230 (860), and the head unit 230 may deliver whether the deleting is successful to the server 10 (870).

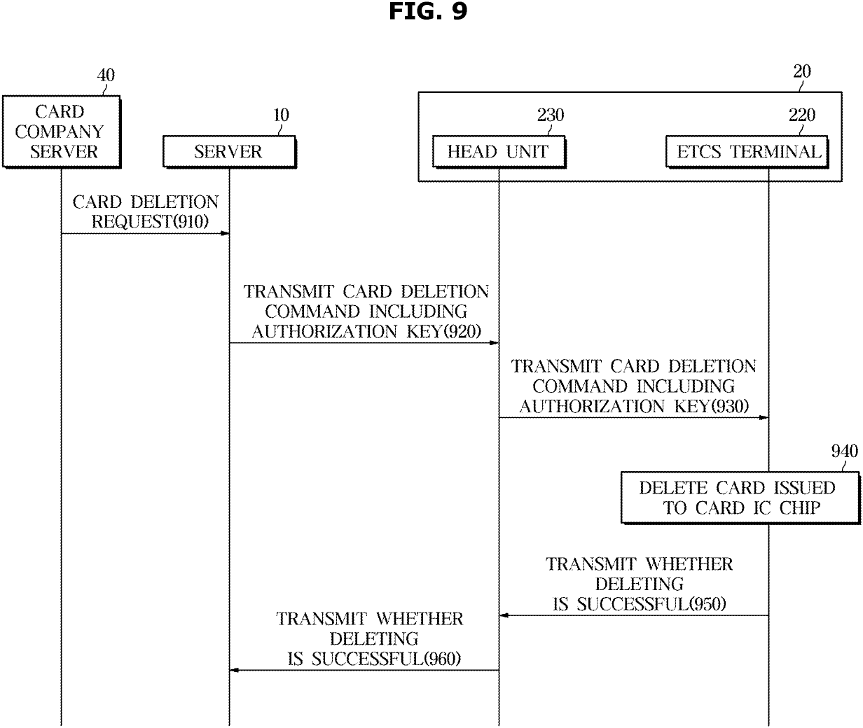

FIG. 9 is a signal flow graph when the server 10 according to an embodiment receives a card deletion request from a card company.

Referring to FIG. 9, when receiving a card deletion request from the card company server 40 (910), the server 10 according to an embodiment may transmit a card deletion command including an authorization key to the vehicle 20 (920). That is, when a card has expired or a payment is outstanding, the card company server 40 may transmit the card deletion request to the server 10. A description regarding operations 930 to 960 of FIG. 9 is the same as that of operations 840 to 870 of FIG. 8, and thus is omitted.

Hereinafter, embodiments of methods of controlling the server 10 and the ETCS terminal 220 according to an aspect of disclosure are described below. The server 10 and the ETCS terminal 220 according to the above-described embodiments may be used in the methods of controlling the server 10 and the ETCS terminal 220. Accordingly, the above description with reference to FIGS. 1 to 9 may be equally applied to the methods of controlling the server 10 and the ETCS terminal 220.

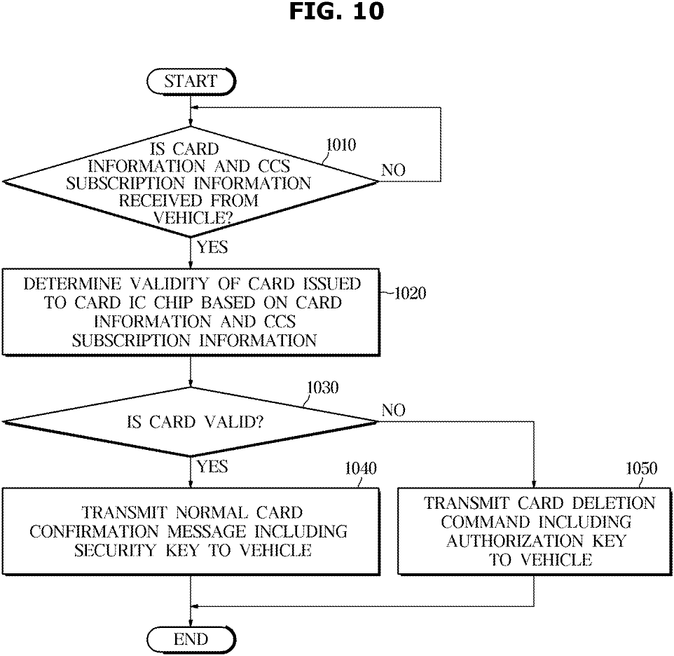

FIG. 10 is a flowchart illustrating operations of determining a validity of a card by the ETCS terminal 220 in a method of controlling the server 10 according to an embodiment.

Referring to FIG. 10, when card information and CCS subscription information is received from the vehicle 20 (Yes in operation 1010), the server 100 according to an embodiment may determine a validity of a card issued to the card IC chip 223 based on the card information and the CCS subscription information (1020).

According to an embodiment, the server 10 may determine the validity of the card issued to the card IC chip 223 based on the card information and the CCS subscription information.

For example, according to embodiments, the server 10 may determine whether an expiration date of the card has passed based on the card information, and when the expiration date of the card has not arrived, determine that the card is valid, and also when the expiration date of the card has arrived, determine that the card is invalid.

Also, according to embodiments, the server 10 may determine whether customer information of the CCS subscription information and issuance-eligible customer information of the card information match, and when the customer information of the CCS subscription information matches the issuance-eligible customer information of the card information, determine that the card is valid, and also when the customer information of the CCS subscription information does not match the issuance-eligible customer information of the card information, determine that the card is invalid.

In addition, according to embodiments, the server 10 may determine whether vehicle information of the CCS subscription information and issuance-eligible vehicle information of the card information match, and when the vehicle information of the CCS subscription information matches the issuance-eligible vehicle information of the card information, determine that the card is valid, and also when the vehicle information of the CCS subscription information does not match the issuance-eligible vehicle information of the card information, determine that the card is invalid.

Further, according to embodiments, the server 10 may determine whether there has been a request for deleting the card based on a card serial number of the card information, and when there has been the request for deleting the card, determine that the card is invalid.

According to an embodiment, when the card is determined to be valid (Yes in operation 1030), the server 10 may transmit a normal card confirmation message including a security key to the vehicle 20 (1040). In this instance, the security key corresponds to a key capable of activating a payment function of the card, and may be issued by a PerSAM. The PerSAM is a card-type security device that is required to be used only according to a specified procedure in order to securely deliver a key for issuing a card (electronic currency). That is, the PerSAM is a module having key information required for issuance, and may be provided by the Korea Expressway Corporation in charge of ETCS.

When receiving the normal card confirmation message including the security key from the head unit 230 through the communication interface 221 in response to the transmission of the card information, the ETCS terminal 220 may activate the card issued to the card IC chip using the security key to perform payment.

When the card is determined to be invalid (No in operation 1030), the server 10 according to an embodiment may transmit a card deletion command including an authorization key to the vehicle 20 (1050). In this instance, the authorization key corresponds to a key having an authority to delete the card and may be issued by the PerSAM.

When receiving the card deletion command including the authorization key from the head unit 230 through the communication interface 221 in response to the transmission of the card information, the ETCS terminal 220 may delete the card issued to the card IC chip using the authorization key. In this instance, deleting the card issued to the card IC chip may be deleting an applet and a SSD corresponding to the card.

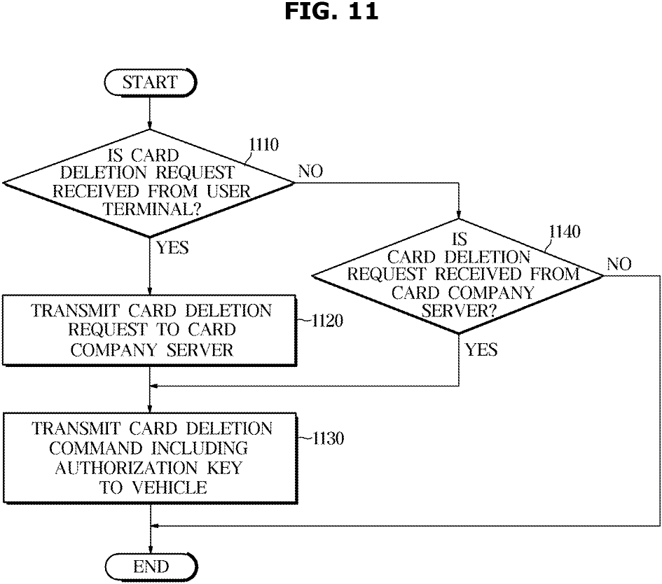

FIG. 11 is a flowchart illustrating operations of receiving a card deletion request from a user or a card company in a method of controlling the server 10 according to an embodiment.

Referring to FIG. 11, when receiving a card deletion request from the user terminal 30 (Yes in operation 1110), the server 10 according to an embodiment may transmit the card deletion request to the card company server 40 (1120) and transmit a card deletion command including an authorization key to the vehicle 20 (1130).

According to an embodiment, when the card deletion request is not received from the user terminal 30 (No in operation 1110) but is received from the card company server 40 (Yes in operation 1140), the server 10 may transmit the card deletion command including the authorization key to the vehicle 20 (1130).

In this case, when receiving the card deletion command including the authorization key from the head unit 230 through the communication interface 221 in response to the transmission of the card information, the ETCS terminal 220 may delete the card issued to the card IC chip using the authorization key. In this instance, deleting the card issued to the card IC chip may be deleting an applet and a SSD corresponding to the card.

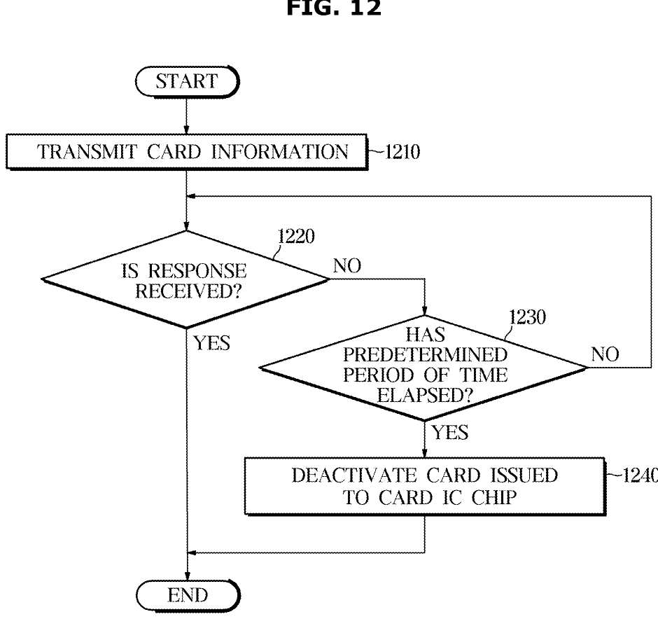

FIG. 12 is a flowchart illustrating operations of deactivating a card issued to the card IC chip 223 in a method of controlling the ETCS terminal 220 according to an embodiment.

Referring to FIG. 12, the ETCS terminal 220 according to an embodiment may transmit card information (1210). In a state where a response is not received (No in operation 1220), when a predetermined period of time has elapsed (Yes in operation 1230), the ETCS terminal 220 may deactivate a card issued to a card IC chip (1240).

That is, when the response is not received after the transmission of the card information, the ETCS terminal 220 may determine that the ETCS terminal is relocated from the vehicle 20 and is connected to an external power, or that a CCS is cancelled, and deactivate the card of the card IC chip, thereby preventing payment. Through the above, the ETCS terminal may be prevented from being forcibly relocated and misused.

As is apparent from the above, according to the embodiments of the disclosure, the server, the ETCS terminal, and the method of controlling the same can determine a validity of a card issued to the ETCS terminal and control deletion or activation of the card, thereby preventing the ETCS terminal from being relocated and misused and enabling an efficient management of the card.

Embodiments can thus be implemented in the form of a recording medium storing computer-executable instructions that are executable by a processor. The instructions may be stored in the form of a program code, and when executed by a processor, the instructions may generate a program module to perform operations of the disclosed embodiments. The recording medium may be implemented non-transitory as a computer-readable recording medium.

The computer-readable code can be recorded on a medium or transmitted through the Internet. The medium may include read only memory (ROM), random access memory (RAM), magnetic tapes, magnetic disks, flash memories, and optical recording medium.

Although embodiments have been described for illustrative purposes, those skilled in the art will appreciate that various modifications, additions and substitutions are possible, without departing from the scope and spirit of the disclosure. Therefore, embodiments have not been described for limiting purposes.

What is claimed is:

1. A server, comprising:
a communicator; and
a controller configured to control the communicator, wherein the controller is configured to:
in response to receiving connected car service (CCS) subscription information and card information from a vehicle through the communicator, determine whether a card issued to a card integrated circuit (IC) chip of an electronic toll collection system (ETCS) terminal of the vehicle is valid, based on the CCS subscription information and the card information;
in response to the card being valid, control the communicator to transmit a normal card confirmation message comprising a security key to the vehicle; and
in response to the card being invalid, control the communicator to transmit a card deletion command comprising an authorization key to the vehicle.

2. The server of claim 1, wherein the controller is configured to determine whether an expiration date of the card has elapsed based on the card information, and in response to the expiration date having elapsed, determine that the card is invalid.

3. The server of claim 1, wherein the controller is configured to determine whether customer information of the CCS subscription information and customer information of the card information match, and in response to the customer information of the CCS subscription information not matching the customer information of the card information, determine that the card is invalid.

4. The server of claim 1, wherein the controller is configured to determine whether vehicle information of the CCS subscription information and vehicle information of the card information match, and in response to the vehicle information of the CCS subscription information not matching the vehicle information of the card information, determine that the card is invalid.

5. The server of claim 1, wherein the controller is configured to determine whether a request for deleting the card is existent based on a card serial number of the card information, and in response to the request for deleting the card being existent, determine that the card is invalid.

6. The server of claim 5, wherein, in response to receiving the request for deleting the card from a user terminal through the communicator, the controller is configured to deliver the request for deleting the card to a server of a card company and control the communicator to transmit the card deletion command comprising the authorization key to the vehicle.

7. The server of claim 5, wherein, in response to receiving the request for deleting the card from a server of a card company through the communicator, the controller is configured to control the communicator to transmit the card deletion command comprising the authorization key to the vehicle.

8. An electronic toll collection system (ETCS) terminal, comprising:
a communication interface configured to be connected to a vehicle network of a vehicle;
a card integrated circuit (IC) chip configured to store card information of an issued card; and
a controller configured to control the communication interface to transmit the card information to a head unit of the vehicle, and in response to a response not being received within a predetermined period of time after transmitting the card information, control the card IC chip to deactivate a card issued to the card IC chip.

9.. The ETCS terminal of claim 8, wherein, in response to receiving a normal card confirmation message comprising a security key from the head unit through the communication interface, the controller is configured to activate the card issued to the card IC chip using the security key.

10. The ETCS terminal of claim 8, wherein, in response to receiving a card deletion command comprising an authorization key from the head unit through the communication interface, the controller is configured to delete the card issued to the card IC chip using the authorization key.

11. A method of controlling a server comprising a communicator, comprising:
in response to receiving connected car service (CCS) subscription information and card information from a vehicle through the communicator, determining whether a card issued to a card integrated circuit (IC) chip of an electronic toll collection system (ETCS) terminal of the vehicle is valid, based on the CCS subscription information and the card information;
in response to the card being valid, controlling the communicator to transmit a normal card confirmation message comprising a security key to the vehicle; and
in response to the card being invalid, controlling the communicator to transmit a card deletion command comprising an authorization key to the vehicle.

12. The method of claim 11, wherein the determining of whether the card is valid comprises:
determining whether an expiration date of the card has elapsed based on the card information; and
in response to the expiration date of the card having elapsed, determining that the card is invalid.

13. The method of claim 11, wherein the determining of whether the card is valid comprises:
determining whether customer information of the CCS subscription information and customer information of the card information match; and
in response to the customer information of the CCS subscription information not matching the customer information of the card information, determining that the card is invalid.

14. The method of claim 11, wherein the determining of whether the card is valid comprises:
determining whether vehicle information of the CCS subscription information and vehicle information of the card information match; and
in response to the vehicle information of the CCS subscription information not matching the vehicle information of the card information, determining that the card is invalid.

15. The method of claim 11, wherein the determining of whether the card is valid comprises:
determining whether a request for deleting the card is existent based on a card serial number of the card information; and
in response to the request for deleting the card being existent, determining that the card is invalid.

16. The method of claim 15, further comprising:
in response to receiving the request for deleting the card from a user terminal through the communicator, delivering the request for deleting the card to a server of a card company and controlling the communicator to transmit the card deletion command comprising the authorization key to the vehicle.

17. The method of claim 15, further comprising:
in response to receiving the request for deleting the card from a server of a card company through the communicator, controlling the communicator to transmit the card deletion command comprising the authorization key to the vehicle.

18. A method of controlling an electronic toll collection system (ETCS) terminal comprising a communication interface, connected to a vehicle network of a vehicle, and a card integrated circuit (IC) chip configured to store card information of an issued card, the method comprising:
controlling the communication interface to transmit the card information to a head unit of the vehicle; and
in response to a response not being received within a predetermined period of time after transmitting the card information, controlling the card IC chip to deactivate a card issued to the card IC chip.

19. The method of claim 18, further comprising:
in response to receiving a normal card confirmation message comprising a security key from the head unit through the communication interface, activating the card issued to the card IC chip using the security key.

20. The method of claim 18, further comprising:
in response to receiving a card deletion command comprising an authorization key from the head unit through the communication interface, deleting the card issued to the card IC chip using the authorization key.
